(19) United States
(12) Patent Application Publication
(10) Pub. No.: US 2026/0158504 A1
(43) Pub. Date: Jun. 11, 2026

(54) SPRAY DEVICES WITH ADJUSTABLE SPRAY RANGES

(71) Applicant: QINGDAO UNIVERSITY OF TECHNOLOGY, Qingdao (CN)

(72) Inventors: Xi MENG, Qingdao (CN); Fudan LIU, Qingdao (CN); Liming GE, Qingdao (CN); Fan HE, Qingdao (CN); Yanna GAO, Qingdao (CN); Shanshan LI, Qingdao (CN); Shuhan LIU, Qingdao (CN); Chenxi HU, Qingdao (CN); Chaonan CHEN, Qingdao (CN); Wanxiang YAO, Qingdao (CN)

(73) Assignee: QINGDAO UNIVERSITY OF TECHNOLOGY, Qingdao (CN)

(21) Appl. No.: 19/354,820

(22) Filed: Oct. 9, 2025

(30) Foreign Application Priority Data
Dec. 10, 2024 (CN) 202411807379.7

(51) Int. Cl. B05B 1/12; B05B 15/62

(52) U.S. Cl. CPC B05B 1/12; B05B 15/62

(57) ABSTRACT

A spray device with an adjustable spray range is provided, including a supporting wall frame, an upper top plate, a movable horizontal plate, a lifting and telescoping device, and an adjustable nozzle. The upper top plate is arranged at a first end of the supporting wall frame away from a ground, the movable horizontal plate is slidably connected to a side of the upper top plate away from the ground, the movable horizontal plate is slidably arranged along a length direction of the upper top plate, and the lifting and telescoping device is fixed at an end of the movable horizontal plate away from the upper top plate; and an end of the lifting and telescoping device away from the movable horizontal plate is connected to a support plate, the lifting and telescoping device is telescopic along a height direction of the support plate, and the adjustable nozzle is rotatably arranged on the support plate.

### CROSS-REFERENCE TO RELATED APPLICATIONS

This application claims priority to Chinese Patent Application No. 202411807379.7, filed on Dec. 10, 2024, the contents of which are hereby incorporated by reference to its entirety.

### TECHNICAL FIELD

The present disclosure relates to the technical field of spray devices, and in particular to a spray device with an adjustable spray range.

### BACKGROUND

Plant wall is a wall woven and planted with green plants, which utilizes the super-strong adaptability of the root system of plants to the growing environment, so that the plants inhabiting the flat ground in nature can grow permanently on vertical building walls, providing a new type of organic ecological material for architectural design and decoration. According to different environmental requirements, people have designed plant wall structures with diverse shapes, staggered heights, and harmony with the surroundings. After careful design and cultivation, the wall tops are decorated with fixtures suitable for plant growth, so that the plant walls are more aesthetically pleasing. The plants are planted in natural patterns such as scattered planting and clump planting, forming a three-dimensional community hierarchical structure with appropriate density, orderly visibility, and staggered heights, promoting improvement of self-sustaining mechanism and biodiversity of the plant wall ecosystem.

Existing indoor plant walls mostly consist of multiple pots placed sequentially on a potting bracket, where different plants are grown to form a small indoor plant wall. The area of the small plant walls is larger than that of individual plants, increasing the user's task of spraying the plants. Existing spraying methods for users are mostly spraying with spray cans, but the capacity of the spray cans is relatively small, and even if all the water in the spray cans is sprayed, it is difficult to spray a whole wall of plants, thereby increasing the labor intensity of users. To this end, a plant wall irrigation system appeared in the prior art, which sprays the plants below by installing a row of sprinklers at the upper end of the plant wall. However, a spray range of the spray equipment of the system is fixed, and generally, only the roots of the plants are sprayed, making it impossible to spray the leaf surfaces of the plants, thus failing to clean the leaf surfaces.

Therefore, it is necessary to provide a spray device with an adjustable spray range, which can effectively adjust the spray range to ensure that any region of a wall can be sprayed, so as to realize uniform spraying and cleaning of leaves.

### SUMMARY

One or more embodiments of the present disclosure provide a spray device with an adjustable spray range, including a supporting wall frame, an upper top plate, a movable horizontal plate, a lifting and telescoping device, and an adjustable nozzle; the upper top plate is arranged at a first end of the supporting wall frame away from a ground, the movable horizontal plate is slidably connected to a side of the upper top plate away from the ground, the movable horizontal plate is slidably arranged along a length direction of the upper top plate, and the lifting and telescoping device is fixed at an end of the movable horizontal plate away from the upper top plate; and an end of the lifting and telescoping device away from the movable horizontal plate is connected to a support plate, the lifting and telescoping device is telescopic along a height direction of the support plate, and the adjustable nozzle is rotatably arranged on the support plate.

In some embodiments, the adjustable nozzle includes a nozzle housing, a rotation adjustment column, and a partition plate, one end of the nozzle housing is provided with a water inlet and the other end of the nozzle housing is provided with a water outlet, and the rotation adjustment column is rotatably connected to the water outlet of the nozzle housing, the rotation adjustment column is rotatable with respect to the water outlet of the nozzle housing, the partition plate is arranged in an inner cavity of the rotation adjustment column, the partition plate divides the inner cavity of the rotation adjustment column into an inner ring water storage cavity and an outer ring water storage cavity, and the inner ring water storage cavity is located on an inner side of the outer ring water storage cavity.

In some embodiments, a surface of an end of the rotation adjustment column close to the water outlet is provided with a plurality of inner ring spray holes and a plurality of outer ring spray holes, the inner ring spray holes are connected with the inner ring water storage cavity, and the outer ring spray holes are connected with the outer ring water storage chamber.

In some embodiments, the adjustable nozzle further includes an adjusting fixing plate, the adjusting fixing plate is arranged in the nozzle housing, the adjusting fixing plate is provided with a first outer ring through-hole and a first inner ring through-hole, the first outer ring through-hole is connected with the outer ring water storage cavity, and the first inner ring through-hole is connected with the inner ring water storage cavity.

In some embodiments, a side of the outer ring water storage cavity close to the adjusting fixing plate is provided with a second outer ring through-hole, a side of the inner ring water storage cavity close to the adjusting fixing plate is provided with a second inner ring through-hole, the first outer ring through-hole is connected with the outer ring water storage cavity through the second outer ring through-hole, the first inner ring through-hole is connected with the inner ring water storage cavity through the second inner ring through-hole, and a center of the first outer ring through-hole, a center of the first inner ring through-hole, and a center of the adjusting fixing plate are not colinear.

In some embodiments, the spray device further includes a plurality of fixing nozzles, and the plurality of fixing nozzles are arranged on a lower surface of the upper top plate.

In some embodiments, the spray device further includes a traversing driving device, and the traversing driving device is connected to the movable horizontal plate.

In some embodiments, a surface of the upper top plate close to the movable horizontal plate is provided with a slide rail, a surface of the movable horizontal plate close to the upper top plate is provided with a slider, and the slider is slidably connected with the slide rail.

In some embodiments, the traversing driving device is a driving hydraulic cylinder, the driving hydraulic cylinder is fixed to the upper top plate, and a telescopic end of the driving hydraulic cylinder is fixedly connected to the slider.

In some embodiments, the support plate is provided with a motor bracket, the motor bracket is fixed with an angle adjusting motor, and the adjustable nozzle includes two connecting rods, the two connecting rods are respectively fixedly connected to two ends of the adjustable nozzle, the two connecting rods are rotatably connected to the motor bracket, and an output shaft of the angle adjusting motor is drivingly connected to a connecting rod close to the angle adjusting motor.

In some embodiments, a water collection tank is provided at a lower end of the supporting wall frame.

In some embodiments, the spray device further includes a water storage tank, the water storage tank includes a water return pipe, a water spray pipe, and a water supply pipe; the water storage tank is connected to the water collection tank via the water return pipe; the water storage tank is connected to the plurality of the fixing nozzles via the water spray pipe; and the water storage tank is connected to a water source through the water supply pipe.

In some embodiments, the water spray pipe is connected to a water inlet of the adjustable nozzle through a connecting hose.

In some embodiments, the spray device includes a liquid level sensor, and the level sensor is arranged in the water storage tank.

In some embodiments, the water spray pipe is provided with a water pump.

In some embodiments, the lifting and telescoping device is a hydraulic cylinder.

The present disclosure includes but is not limited to the following beneficial effects. The disclosure can change a horizontal position of an adjustable nozzle 5 through the movable horizontal plate and change a vertical position of the adjustable nozzle 5 through the lifting and telescoping device, so that an actual position of the adjustable nozzle 5 can be adjusted according to actual requirements. Further, the adjustable nozzle 5 itself has two water spraying modes: water spraying from outer ring spray holes 524 and water spraying from inner ring spray holes 523. Through the combined effect of these two modes, a spray range of the adjustable nozzle 5 can be effectively adjusted, ensuring that it can spray any desired region.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating a structure of a spray device with an adjustable spray range according to some embodiments of the present disclosure;

FIG. 2 is a schematic diagram illustrating a structure of a spray device with an adjustable spray range according to other embodiments of the present disclosure;

FIG. 3 is a schematic diagram illustrating a connection of a traversing driving device according to some embodiments of the present disclosure;

FIG. 4 is a schematic diagram illustrating an internal structure of an adjustable nozzle 5 according to some embodiments of the present disclosure;

FIG. 5 is a schematic diagram illustrating a sectional structure of a rotation adjustment column 52 along an axis A-A as shown in FIG. 4;

FIG. 6 is a schematic diagram illustrating a sectional structure of an adjusting fixing plate 54 along an axis B-B as shown in FIG. 4;

FIG. 7 is a schematic diagram illustrating a sectional structure of a rotation adjustment column 52 along an axis B-B as shown in FIG. 4; and

FIG. 8 is a schematic diagram illustrating a structure of a support plate 6 according to some embodiments of the present disclosure.

Description of reference numerals: 1. supporting wall frame; 2. upper top plate; 21. slide rail; 22. slider; 3. movable horizontal plate; 31. fixed end; 32. driving hydraulic cylinder; 33. telescopic end; 4. lifting and telescoping device; 5. adjustable nozzle; 51. nozzle housing; 511. ring protrusion; 52. rotation adjustment column; 521. inner ring water storage cavity; 522. outer ring water storage cavity; 523. inner ring spray holes; 524. outer ring spray holes; 525. second inner ring through-hole; 526. second outer ring through-hole; 53. partition plate; 54. adjusting fixing plate; 541. first inner ring through-hole; 542. first outer ring through-hole; 55. connecting hose; 56. connecting rod; 6. support plate; 61, motor bracket; 62. angle adjusting motor; 7. fixing nozzle; 8. water collection tank; 9. water storage tank; 91. water return pipe; 92. water spray pipe; 93. water supply pipe; 94. liquid level sensor; 95. water pump.

### DETAILED DESCRIPTION

In order to more clearly illustrate the technical solutions of the embodiments of the present disclosure, the accompanying drawings required to be used in the description of the embodiments will be briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system”, “device”, “unit”, and/or “module” used herein are ways for distinguishing different levels of components, elements, parts, or assemblies. However, if other terms can achieve the same purpose, they may be used as alternatives.

As shown in the present disclosure, unless the context clearly suggests an exception, the singular forms “a”, “an”, and “the” may be intended to include the plural forms as well. In general, the terms “comprise”, “comprises”, and/or “comprising”, “include”, “includes” and/or “including” only suggest the inclusion of explicitly identified steps and elements that do not constitute an exclusive list, and the method or device may also include other steps or elements.

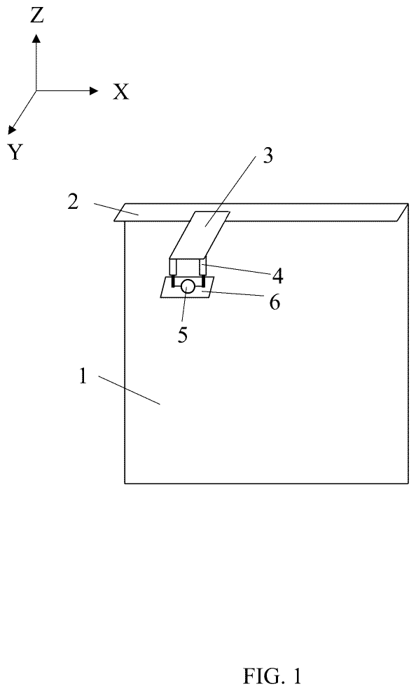

FIG. 1 is a schematic diagram illustrating a structure of a spray device with an adjustable spray range according to some embodiments of the present disclosure.

In some embodiments, as shown in FIG. 1, the spray device with the adjustable spray range includes a supporting wall frame 1, an upper top plate 2, a movable horizontal plate 3, a lifting and telescoping device 4, and an adjustable nozzle 5. In some embodiments, the upper top plate 2 is arranged at an end (also referred to as an upper end of the supporting wall frame 1) of the supporting wall frame 1 away from a ground, the movable horizontal plate 3 is slidably connected to a side (also referred to as an upper end of the upper top plate 2) of the upper top plate 2 away from the ground, the movable horizontal plate 3 is slidably arranged along a length direction of the upper top plate 2, and the lifting and telescoping device 4 is fixed at an end of the movable horizontal plate 3 away from the upper top plate 2. In some embodiments, an end of the lifting and telescoping device 4 away from the movable horizontal plate is connected to a support plate 6, the lifting and telescoping device 4 is telescopic along a height direction of the support plate 6, and the adjustable nozzle 5 is rotatably arranged on the support plate 6.

The supporting wall frame 1 is used to support components of the spray device with the adjustable spray range. In some embodiments, the supporting wall frame 1 is a steel frame structure and is fixed flush against a wall. In some embodiments, a side of the supporting wall frame 1 away from a wall may be provided with a planter stand for mounting plants.

The upper top plate 2 is used to support the movable horizontal plate 3 and provide a position for the movement of the movable horizontal plate 3. In some embodiments, the upper top plate 2 is arranged perpendicular to the wall. Exemplarily, as shown in FIG. 1, the wall is a plane where a Z-axis and an X-axis are located, and the upper top plate 2 is arranged along the plane where the X-axis and a Y-axis are located.

In some embodiments, the upper top plate 2 may be fixedly arranged at the end of the supporting wall frame 1 away from the ground in a plurality of ways. For example, the upper top plate 2 may be fixed to the support wall frame 1 by screws, welding, or other means, without limitation herein.

The movable horizontal plate 3 is used to drive the adjustable nozzle 5 to move horizontally (e.g., along the X-axis direction).

In some embodiments, an external force is applied to the movable horizontal plate 3, and the movable horizontal plate 3 may move along the length direction (e.g., the X direction) of the upper top plate 2, thereby driving the adjustable nozzle 5 to move synchronously with the movable horizontal plate 3.

In some embodiments, the movable horizontal plate 3 may be slidably connected to the upper top plate 2 in a plurality of ways. For example, the movable horizontal plate 3 may be slidably connected to the upper top plate 2 via a guide rail and a guide rod, etc.

In some embodiments, an end of the movable horizontal plate 3 is connected to the upper top plate 2, and the other end of the movable horizontal plate 3 is at least partially suspended, and the lifting and telescoping device 4 and the adjustable nozzle 5 are arranged at a suspended end of the movable horizontal plate 3.

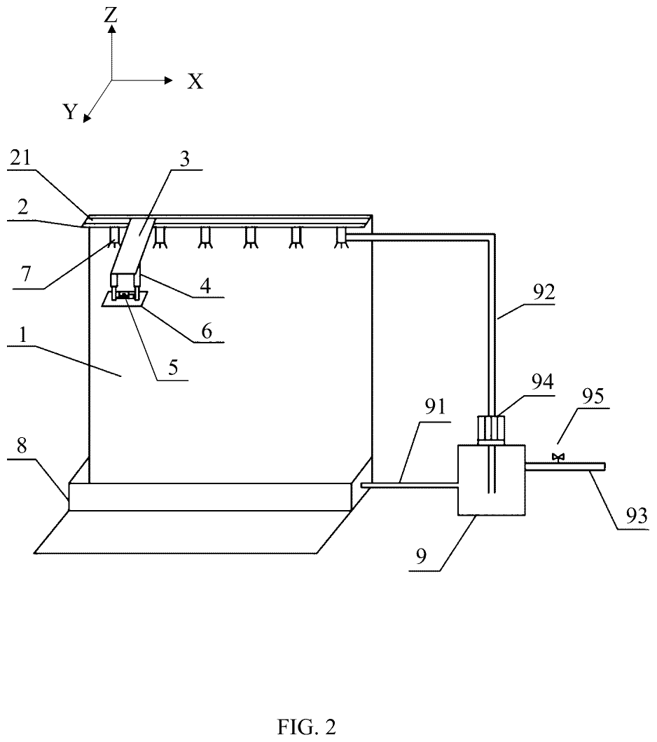

FIG. 2 is a schematic diagram illustrating a structure of a spray device with an adjustable spray range according to other embodiments of the present disclosure.

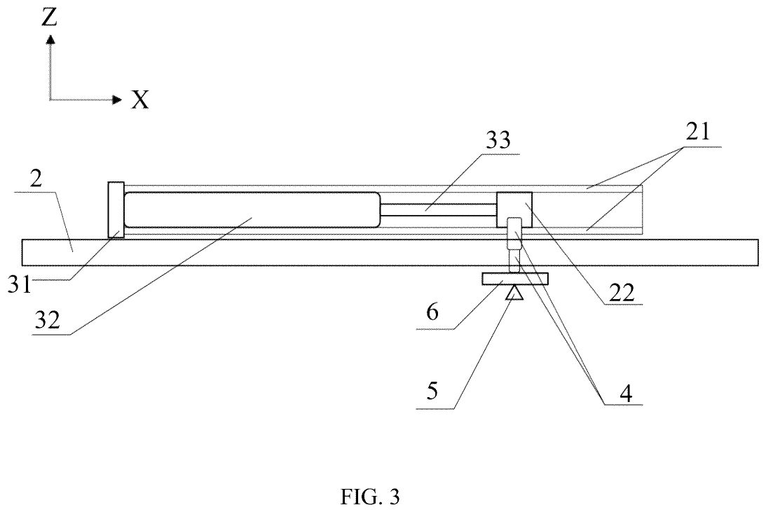

In some embodiments, a surface of the upper top plate 2 close to the movable horizontal plate 3 is provided with a slide rail 21, a surface of the movable horizontal plate 3 close to the upper top plate is provided with a slider 22 (referring to FIG. 3), and the slider 22 is slidably connected with the slide rail 21

In some embodiments, the slide rail 21 may be a groove arranged along the length direction (e.g., in the X direction) of the upper top plate 2. The slider 22 is fixed to the surface of the movable horizontal plate 3 close to the upper top plate 2. A size of the slider 22 matches a size of the slide rail 21. The movable horizontal plate 3 may move in the slide rail 21 via the slider 22, thereby realizing that the movable horizontal plate 3 moves along the length direction of the upper top plate 2.

In some embodiments, a cross-section of the slider 22 is the same as a cross-section of the slide rail 21. In some embodiments, both the cross-section of the slider 22 and the cross-section of the slide rail 21 are special-shaped cross-sections (e.g., T-shaped cross-sections, etc.), thereby preventing the slider 22 from slipping out of a side of the slide rail 21 when the slider is moving along the slide rail 21.

In some embodiments of the present disclosure, the slide rail 21 and the slider 22 can cooperate to drive the adjustable nozzle 5 to move along the length direction of the upper top plate 2, so as to increase a horizontal spray range of the spray device.

In some embodiments, the spray device further includes a traversing driving device, and the traversing driving device is connected to the movable horizontal plate 3.

The traversing driving device is used to provide a power source to cause the movable horizontal plate 3 to move horizontally. For example, the traversing driving device may be a cylinder, a stepper motor, a hand crank wheel, a pulley system, or the like. In some embodiments, the traversing driving device is capable of driving the movable horizontal plate 3 to move along the length direction (e.g., the X-axis direction) of the upper top plate 2.

In some embodiments, the traversing driving device is connected to the slider 22, and the traversing driving device may drive the slider 22 to move in the slide rail 21 along the length direction (e.g., the X-axis direction) of the upper top plate 2, thereby driving the movable horizontal plate 3 to move along the length direction of the upper top plate 2.

In some embodiments of the present disclosure, the traversing driving device can enable the movable horizontal plate 3 to move horizontally more easily, improving the flexibility and adaptability of the spray device. The user can realize automatic or remote control by the traversing driving device, which reduces the complexity of manual operation and improves work efficiency.

FIG. 3 is a schematic diagram illustrating a connection of a traversing driving device according to some embodiments of the present disclosure. In some embodiments, as shown in FIG. 3, the traversing driving device is a driving hydraulic cylinder 32, the driving hydraulic cylinder 32 is fixed to the upper top plate 2, and a telescopic end 33 of the driving hydraulic cylinder 32 is fixedly connected to the slider 22.

In some embodiments, the driving hydraulic cylinder 32 is fixed at one end of the upper top plate 2 along the length direction. The driving hydraulic cylinder 32 may telescope along the length direction (e.g., the X-axis direction) of the upper top plate 2.

In some embodiments, a fixed end 31 of the driving hydraulic cylinder 32 is fixed on the upper top plate 2. The fixed end 31 may be fixed through manners such as welding, bonding, bolting, or the like onto the upper top plate 2. In some embodiments, the driving hydraulic cylinder 32 may drive the slider 22 to make reciprocating linear movement along the slide rail 21 through a telescopic movement of the telescopic end 33, thereby driving the movable horizontal plate 3 to move along the length direction of the upper top plate 2.

In some embodiments of the present disclosure, by using the driving hydraulic cylinder as the traversing driving device, fast and smooth movement can be realized, significantly improving the operation efficiency of the spray device.

The lifting and telescoping device 4 is used to adjust a height of the adjustable nozzle 5.

In some embodiments, one end of the lifting and telescoping device 4 is fixed to the movable horizontal plate 3, and the other end of the lifting and telescoping device 4 is connected to the support plate 6. The support plate 6 is used to carry the adjustable nozzle 5.

In some embodiments, as shown in FIG. 1 and FIG. 2, a height of the lifting and telescoping device 4 along the Z-axis direction is adjustable. In some embodiments, the lifting and telescoping device 4 may achieve lifting through a cylinder, an electric telescopic rod, or the like. For example, when the lifting and telescoping device 4 contracts, the adjustable nozzle 5 is driven to move close to the movable horizontal plate 3, thereby increasing the height of the adjustable nozzle 5; and when the lifting and telescoping device 4 extends, the adjustable nozzle 5 is driven to move away from the movable horizontal plate 3, thereby decreasing the height of the adjustable nozzle 5.

In some embodiments, a height telescoping range of the lifting and telescoping device 4 may be set based on requirements, so that the adjustable nozzle 5 can spray plants at each height on the supporting wall frame 1.

In some embodiments, the lifting and telescoping device 4 is a hydraulic cylinder.

In some embodiments, two, four, or more hydraulic cylinders may be provided. A fixed end of the hydraulic cylinder is fixed to a lower surface of the movable horizontal plate 3, and a telescopic end of the hydraulic cylinder is fixed to the support plate 6. The hydraulic cylinder may change the height of the hydraulic cylinder through a telescopic movement, thereby driving the support plate 6 and a structural member on the support plate 6 to move along the height direction (e.g., the Z-axis direction).

In some embodiments of the present disclosure, the height of the nozzle can be stabilized and accurately controlled by the hydraulic cylinder to adapt to the spray requirements of different plants or regions.

In some embodiments, the spray device with the adjustable spray range also includes a controller, the traversing driving device and the lifting and telescoping device 4 are both electrically connected to the controller, and a user may realize a remote control of the traversing driving device and the lifting and telescoping device 4 through the controller. In some embodiments, the controller may include a Programmable Logic Controller (PLC), a single-chip microcontroller, or the like.

The adjustable nozzle 5 is used for spraying mist and adjusting a direction of the mist. In some embodiments, the adjustable nozzle 5 may be rotatably arranged on the support plate 6 in a plurality of ways. For example, the adjustable nozzle 5 may be rotatably arranged on the support plate 6 by a rotation shaft or a bracket, and by applying an external force to the rotation shaft or the bracket, the adjustable nozzle 5 may be driven to rotate, so as to change a spray angle of the adjustable nozzle 5.

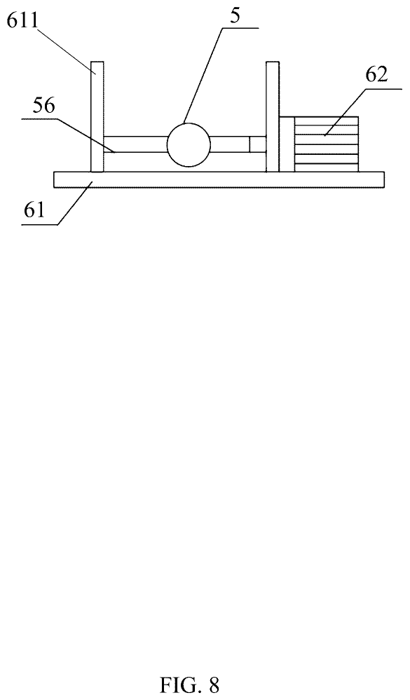

In some embodiments, the adjustable nozzle 5 may also be rotatably arranged on the support plate 6 via a motor bracket 61 and the connecting rods 56. More descriptions regarding the content herein may be found in FIG. 8 and the related descriptions.

In some embodiments, the spray device further includes a plurality of fixing nozzles 7, and the plurality of fixing nozzles 7 are arranged on a lower surface of the upper top plate 2.

The fixed nozzles 7 are used for spraying the mist, with a fixed spray direction and range. The fixed nozzles 7 are used to spray a mist with the spray direction toward a preset position. The preset position may be set based on requirements. For example, the preset position is a root of a plant on the supporting wall frame 1, and the fixed nozzles 7 may spray the root of the plant on the supporting wall frame 1.

By providing the fixed nozzles 7, it can ensure the stability and consistency of the spray device when spraying at a specific location.

Through a cooperation of the supporting wall frame 1, the upper top plate 2, the movable horizontal plate 3, the lifting and telescoping device 4, and the adjustable nozzle 5, some embodiments of the present disclosure enable the user to adjust the spray height and direction according to the requirements of different scenarios, which improves the flexibility of use. By means of the movable horizontal plate 3, the lifting and telescoping device 4, and the rotatable adjustable nozzle 5, the coverage range of the spray device can be adjusted, thereby satisfying the extensive application requirements of the user.

It should be noted that the above description of the spray device with the adjustable spray range and its components is only for the convenience of description, and it does not limit the present disclosure to the scope of the embodiments cited. It is to be understood that for those skilled in the art, after understanding a principle of the spray device, they may arbitrarily combine the components of the spray device or form other devices to connect with the spray device without departing from the principle.

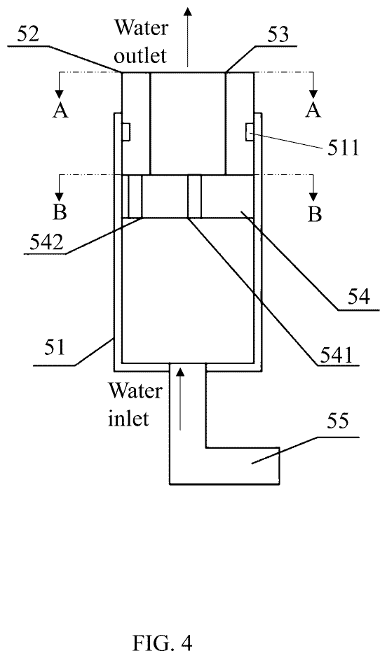

FIG. 4 is a schematic diagram illustrating an internal structure of an adjustable nozzle 5 according to some embodiments of the present disclosure.

In some embodiments, as shown in FIG. 4, the adjustable nozzle 5 includes a nozzle housing 51, a rotation adjustment column 52, and a partition plate 53, one end of the nozzle housing 51 is provided with a water inlet and the other end of the nozzle housing 51 is provided with a water outlet, the rotation adjustment column 52 is rotatably connected to the water outlet of the nozzle housing 51, the rotation adjustment column is rotatable with respect to the water outlet of the nozzle housing 51, the partition plate 53 is arranged in an inner cavity of the rotation adjustment column 52, the partition plate 53 divides the inner cavity of the rotation adjustment column 52 into an inner ring water storage cavity 521 and an outer ring water storage cavity 522, and the inner ring water storage cavity 521 is located on an inner side of the outer ring water storage cavity 522.

The nozzle housing 51 refers to a housing of the adjustable nozzle 5, and the nozzle housing 51 is used to protect internal components of the adjustable nozzle 5. In some embodiments, the nozzle housing 51 is a hollow cylindrical structure. The water inlet of the nozzle housing 51 is used to introduce a water source. The water outlet of the nozzle housing 51 is used for spraying.

The rotation adjustment column 52 is used to adjust a spray mode of the adjustable nozzle 5.

In some embodiments, as shown in FIG. 4, a ring protrusion 511 is provided near the water outlet of the nozzle housing 51, and a protrusion direction of the ring protrusion 511 is oriented toward the rotation adjustment column 52. An outer wall of the rotation adjustment column 52 is provided with a ring groove (not shown in the figure) that matches the ring protrusion 511. The rotation adjustment column 52 is rotatably connected to the nozzle housing 51 through a cooperation of the ring groove with the ring protrusion 511.

The inner ring water storage cavity 521 is used to store the water source on an outer side of the rotation adjustment column 52. The outer ring water storage cavity 522 is used to store the water source on the inner side of the rotation adjustment column 52. In some embodiments, both the inner ring water storage cavity 521 and the outer ring water storage cavity 522 are in communication with the adjustable nozzle 5. By rotating the rotation adjustment column 52, the ring protrusion 511 is driven to rotate along the ring groove, enabling the water inlet to communicate with the inner ring water storage cavity 521 or the outer ring water storage cavity 522, thereby allowing the adjustable nozzle 5 to spray water through the inner water storage cavity 521 or the outer water storage cavity 522.

The partition plate 53 is used to separate the inner ring water storage cavity 521 and the outer ring water storage cavity 522, ensuring that water flows in the inner ring water storage cavity 521 and the outer ring water storage cavity 522 do not interfere with each other. In some embodiments, the partition plate 53 is ring-shaped.

In some embodiments of the present disclosure, the rotation adjustment column 52 enables the adjustable nozzle 5 to switch between different spray modes, and the partition plate 53 effectively separates the inner ring water storage cavity 521 and the outer ring water storage cavity 522 to ensure that different spray holes are able to work without interfering with each other, thereby enhancing the uniformity and effect of spraying.

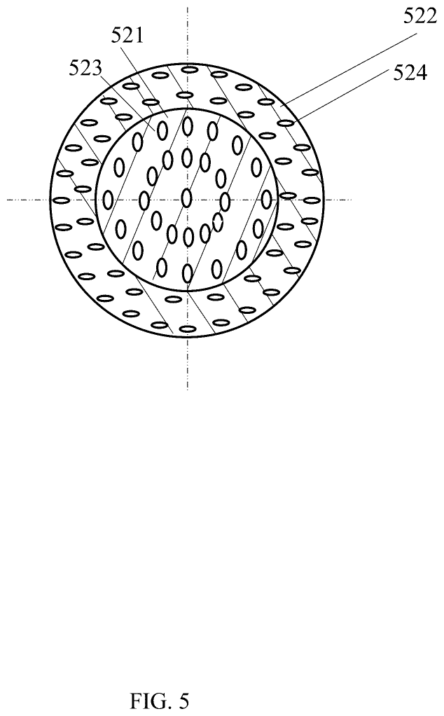

FIG. 5 is a schematic diagram illustrating a sectional structure of a rotation adjustment column 52 along an axis A-A as shown in FIG. 4.

In some embodiments, as shown in FIG. 4 and FIG. 5, a surface of an end of the rotation adjustment column 52 close to the water outlet (i.e., away from the water inlet) is provided with a plurality of inner ring spray holes 523 and a plurality of outer ring spray holes 524, the inner ring spray holes 523 are connected with the inner ring water storage cavity 521, and the outer ring spray holes 524 are connected with the outer ring water storage cavity 522. Water in the inner ring water storage cavity 521 is sprayed out through the inner ring spray holes 523, and water in the outer ring water storage cavity 522 is sprayed out through the outer ring spray holes 524.

The inner ring spray holes 523 refer to water spray holes on a surface of an inner side of the rotation adjustment column 52 close to the water outlet. The outer ring spray holes 524 refer to water spray holes on a surface of an outer side of the rotation adjustment column 52 close to the water outlet. The inner ring spray holes 523 are provided through a surface of an end of the rotation adjustment column 52 close to the water outlet, so that the inner ring spray holes 523 are connected with the inner ring water storage cavity 521. The outer ring spray holes 524 are provided through the surface of the end of the rotation adjustment column 52 close to the water outlet, so that the outer ring spray holes 524 are connected with the outer ring water storage cavity 522.

In some embodiments, as shown in FIG. 5, the inner ring spray holes 523 and the outer ring spray holes 524 are provided in a ring pattern on a surface of an end of the rotation adjustment column 52 away from the water inlet, and the outer ring spray holes 524 are located on outer sides of the inner ring spray holes 523.

In some embodiments, diameters of the inner ring spray holes 523 are smaller than diameters of the outer ring spray holes 524.

In some embodiments, the diameters of the inner ring spray holes 523 range from 0.5 mm to 1.5 mm.

In some embodiments, the diameters of the inner ring spray holes 523 range from 0.5 mm to 0.8 mm, 0.8 mm to 1.0 mm, or 1.0 mm to 1.2 mm.

In some embodiments, the diameters of the inner ring spray holes 523 are 0.5 mm, 0.8 mm, 1.0 mm, or 1.2 mm.

In some embodiments, the diameters of the outer ring spray holes 524 range from 1.5 mm to 3.0 mm.

In some embodiments, the diameters of the outer ring spray holes 524 range from 1.5 mm to 2.0 mm, 2.0 mm to 2.5 mm, or 2.5 mm to 3.0 mm.

In some embodiments, the diameters of the outer ring spray holes 524 are 1.5 mm, 2.0 mm, 2.5 mm, or 3.0 mm.

In some embodiments of the present disclosure, the adjustable nozzle 5 can provide a concentrated and stable spray flow through the inner ring spray holes 523, which is suitable for precise irrigation or spraying on a specific region; and through the outer ring spray holes 524, a wider spray range can be provided, which is suitable for irrigation or spraying needs of large-area regions. The inner ring spray holes 523 and the outer ring spray holes 524 can work together to satisfy diverse irrigation or spraying requirements.

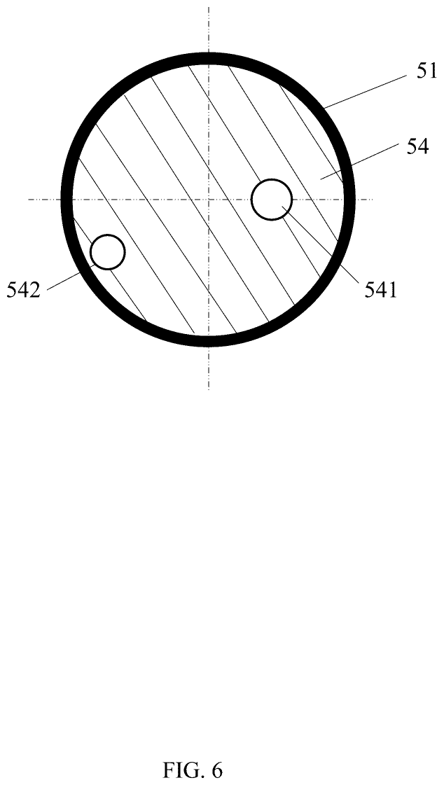

FIG. 6 is a schematic diagram illustrating a sectional structure of an adjusting fixing plate 54 along an axis B-B as shown in FIG. 4.

In some embodiments, as shown in FIG. 4 and FIG. 6, the adjustable nozzle 5 further includes an adjusting fixing plate 54, the adjusting fixing plate 54 is arranged in the nozzle housing 51, the adjusting fixing plate 54 is provided with a first outer ring through-hole 542 and a first inner ring through-hole 541, the first outer ring through-hole 542 is connected with the outer ring water storage cavity 522, and the first inner ring through-hole 541 is connected with the inner ring water storage cavity 521.

The adjusting fixing plate 54 is used to adjust a position where water flows into the rotation adjustment column 52. The adjusting fixing plate 54 is a disc structure, and an outer diameter of the adjusting fixing plate 54 is the same as an inner diameter of the nozzle housing 51. In some embodiments, the adjusting fixing plate 54 may be fixed to an inside of the nozzle housing 51 by bolts, clasps, or the like.

The first outer ring through-hole 542 is used to direct water flow to the outer ring water storage cavity 522. The first inner ring through-hole 541 is used to direct the water flow to the inner ring water storage cavity 521.

In some embodiments, as shown in FIG. 4, the first outer ring through-hole 542 and the first inner ring through-hole 541 are provided through the adjusting fixing plate 54 in a direction from the water inlet to the water outlet.

In some embodiments of the present disclosure, the adjusting fixing plate 54 ensures that the individual water flow channels of the adjustable nozzle 5 are stable and less prone to leakage or poor water flow. The first outer ring through-hole 542 and the inner ring through-hole 541 can ensure that each water storage cavity is effectively supplied with water.

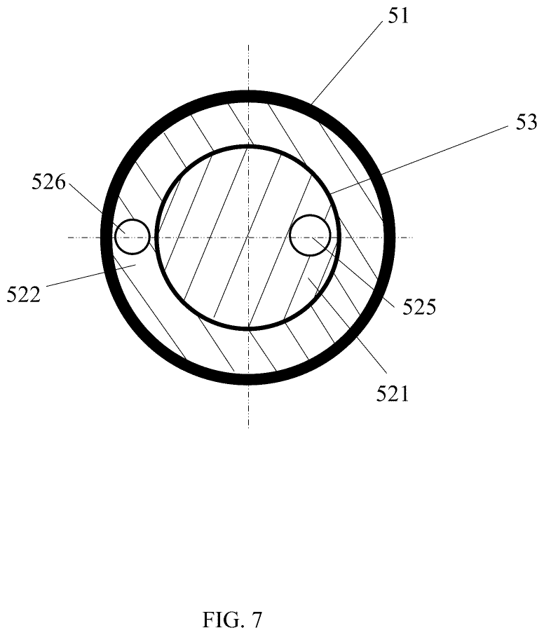

FIG. 7 is a schematic diagram illustrating a sectional structure of a rotation adjustment column 52 along an axis B-B as shown in FIG. 4.

In some embodiments, as shown in FIGS. 4-7, a side of the outer ring water storage cavity 522 close to the adjusting fixing plate 54 is provided with a second outer ring through-hole 526, a side of the inner ring water storage cavity 521 close to the adjusting fixing plate 54 is provided with a second inner ring through-hole 525, the first outer ring through-hole 542 is connected with the outer ring water storage cavity 522 through the second outer ring through-hole 526, the first inner ring through-hole 541 is connected with the inner ring water storage cavity 521 through the second inner ring through-hole 525, and a center of the first outer ring through-hole 542, a center of the first inner ring through-hole 541, and a center of the adjusting fixing plate 54 are not colinear.

In some embodiments, the center of the second outer ring through-hole 526, the center of the second inner ring through-hole 525, and the center of the adjusting fixing plate 54 may be colinear (as shown in FIG. 7) or not colinear, and at most only one of an outer ring alignment condition and an inner ring alignment condition may be satisfied. The outer ring alignment condition refers to that the first outer ring through-hole 542 is directly opposite to the second outer ring through-hole 526. The inner ring alignment condition refers to a condition where the first inner ring through-hole 541 is directly opposite the second inner ring through-hole 525.

In some embodiments, as shown in FIG. 6 and FIG. 7, when the rotation adjustment column 52 is rotated until the first inner ring through-hole 541 is directly opposite to the second inner ring through-hole 525, the first inner ring through-hole 541 is connected with the inner ring water storage cavity 521, and at this time, the first outer ring through-hole 542 is not directly opposite to the second outer ring through-hole 526, that is, the first outer ring through-hole 542 is not connected with the outer ring water storage cavity 522. When the rotation adjustment column 52 is rotated until the first outer ring through-hole 542 is directly opposite to the second outer ring through-hole 526, the first outer ring through-hole 542 is connected with the outer ring water storage cavity 522, at the same time, the first inner ring through-hole 541 is not directly opposite to the second inner ring through-hole 525, that is, the first inner ring through-hole 541 is not connected with the inner ring water storage cavity 521.

In some embodiments of the present disclosure, the eccentric design of the non-collinear centers makes the water flow from the various nozzles independent, which reduces the mutual interference in the spray process and ensures the accuracy and reliability of the spray process. By reasonably configuring a plurality of through-holes, the overall design is more compact, improves the integration level of the spray device, and facilitates production and maintenance.

In some embodiments, by driving the movable horizontal plate 3 to move along the length direction of the upper top plate 2, the adjustable nozzle 5 may be moved horizontally (e.g., in the X-axis direction), and by telescoping the lifting and telescoping device 4, the adjustable nozzle 5 may be moved longitudinally (e.g., in the Z-axis direction), so as to enable the adjustable nozzle 5 to reach the front of the plant that needs to be sprayed. By twisting the rotation adjustment column 52, when the first outer ring through-hole 542 is directly opposite to the second outer ring through-hole 526, the first outer ring through-hole 542 is connected with the outer ring water storage cavity 522, and at this time, the outer ring spray holes 524 carry out the spray work; by twisting the rotation adjustment column 52, when the first inner ring through-hole 541 is directly opposite to the second inner ring through-hole 525, the first inner ring through-hole 541 is connected with the inner ring water storage cavity 521, and at this time, the inner ring spray holes 523 carry out the spray work. During the spray process, the adjustable nozzle 5 carries out the spray operation on the surface of the plant, and the fixing nozzles 7 carry out the spray on the root of the plant, so as to realize the all-round spray operation of the spray device on the wall of the plant.

FIG. 8 is a schematic diagram illustrating a structure of a support plate 6 according to some embodiments of the present disclosure.

In some embodiments, as shown in FIG. 8, the support plate 6 is provided with a motor bracket 61, the motor bracket 61 is fixed with an angle adjusting motor 62, and the adjustable nozzle 5 includes two connecting rods 56, the two connecting rods 56 are respectively fixedly connected to two ends of the adjustable nozzle 5, the two connecting rods 56 are rotatably connected to the motor bracket 61, and an output shaft of the angle adjusting motor 62 is drivingly connected to the connecting rod 56 close to the angle adjusting motor 62.

The motor bracket 61 is used to support and fix the angle adjusting motor 62, ensuring that the angle adjusting motor 62 is not displaced or vibrated during operation. In some embodiments, as shown in FIG. 8, the motor bracket 61 is provided with vertical plates 611 at both ends, and the vertical plates 611 are rotatably connected to the connecting rods 56, so that the motor bracket 61 is rotatably connected to the connecting rods 56. For example, the vertical plates 611 may be rotatably connected to the connecting rods 56 by bearings, or the like.

The angle adjusting motor 62 is used to drive the connecting rods 56 to rotate, thereby changing the spray angle of the adjustable nozzle 5. For example, the angle adjusting motor 62 may be a servo motor, a stepper motor, etc.

In some embodiments, the angle adjusting motor 62 is electrically connected to the controller, and the user may adjust the angle adjusting motor 62 via the controller, thereby realizing remote adjustment of the spray angle of the adjustable nozzle 5. More descriptions regarding the controller may be found in the preceding related descriptions.

The connecting rods 56 are used to connect the adjustable nozzle 5 to the motor bracket 61 and transmit power output from the angle adjusting motor 62.

In some embodiments, when the angle adjusting motor 62 is activated, the output shaft of the angle adjusting motor 62 drives the connecting rod 56 close to the angle adjusting motor 62 to rotate, thereby driving the adjustable nozzle 5 and the other connecting rod 56 to synchronously rotate, thereby adjusting the spray angle of the adjustable nozzle 5.

In some embodiments of the present disclosure, through the cooperation of the motor bracket 61, the angle adjusting motor 62, and the connecting rods 56, flexible adjustment of the spray angle of the adjustable nozzle 5 can be realized, so as to realize accurate irrigation of different regions, improve operational efficiency, and reduce water waste. The remote control of the adjustable nozzle 5 can be realized by the angle adjusting motor 62, which improves the convenience and operational efficiency.

In some embodiments, as shown in FIG. 2, a water collection tank 8 is provided at a lower end of the supporting wall frame 1.

The water collection tank 8 is used to collect water that falls to the ground during the spray process. In some embodiments, a lower end of the planter stand is arranged within the water collection tank 8. In some embodiments, the water collection tank 8 is made of a corrosion-resistant plastic, metal, or the like.

The water collection tank 8 can collect water dripping from the plants mounted on the planter stand during the spray process, thereby avoiding water waste.

In some embodiments, as shown in FIG. 2, the spray device further includes a water storage tank 9, the water storage tank 9 includes a water return pipe 91, a water spray pipe 92, and a water supply pipe 93. In some embodiments, the water storage tank 9 is connected to the water collection tank 8 via the water return pipe 91; the water storage tank 9 is connected to the plurality of fixing nozzles 7 via the water spray pipe 92; and the water storage tank 9 is connected to a water source via the water supply pipe 93.

The water storage tank 9 is used for storing water collected by the water collection tank 8 and supplying water required for spraying by the spray device to ensure water circulation in the spray process.

The water return pipe 91 is used to direct the water collected by the water collection tank 8 to flow back to the water storage tank 9.

The water spray pipe 92 is used to supply the water required for spraying to the fixing nozzles 7 and the adjustable nozzle 5.

In some embodiments, as shown in FIG. 2 and FIG. 4, the water spray pipe 92 is connected to a water inlet of the adjustable nozzle 5 through a connecting hose 55.

In some embodiments, the connecting hose 55 is made of a flexible material such as a silicone, PVC material, or the like.

In some embodiments, the water spray pipe 92 and the connecting hose 55 may be connected by a clamp or a joint.

In some embodiments, a diameter of the water spray pipe 92 may be slightly larger than a diameter of the connecting hose 55, thereby ensuring a tight connection between the water spray pipe 92 and the connecting hose 55 to avoid water leakage.

During the spray process, when adjusting the movable horizontal plate 3 and the lifting and telescoping device 4 to cause that the adjustable nozzle 5 is sprayed at different positions, the flexibility of the connecting hose 55 ensures that the water spray pipe 92 is always connected to the adjustable nozzle 5.

In some embodiments, the water spray pipe 92 is provided with a water pump 95.

The water pump 95 is used to supply power for the water spray pipe 92. In some embodiments, a power of the water pump 95 may be set based on requirements or experiences. In some embodiments, the water pump 95 is connected to the water spray pipe 92 by flanges, threads, or the like, so that water in the water storage tank 9 is pumped out and conveyed to the nozzle for spraying.

In some embodiments of the present disclosure, the arrangement of the water pump 95 improves the efficiency of the water delivery, thereby enhancing the overall work efficiency and the spray effect of the spray device.

The water supply pipe 93 is used to connect to the water source to ensure that there is enough water in the water storage tank 9 for spraying. The water source may be a tap water pipe.

In some embodiments, the spray device includes a liquid level sensor 94, and the liquid level sensor 94 is arranged in the water storage tank 9.

The liquid level sensor 94 is used to monitor a height of a liquid level within the water storage tank 9. For example, the liquid level sensor 94 may be a float liquid level sensor 94 or an ultrasonic liquid level sensor 94, etc.

In some embodiments, the liquid level sensor 94 is electrically or communicatively connected to the controller. When the liquid level in the water storage tank 9 falls below a preset level, the water pump 95 and a water switch are turned on, and the water is supplied to the water storage tank 9 in a timely manner through the water supply pipe 93.

In some embodiments of the present disclosure, the liquid level sensor 94 enables monitoring of the liquid level of the water storage tank 9, so as to adjust the water supply and irrigation in time to ensure the water supply, ensuring the continuity of the spray device when spraying.

In some embodiments of the present disclosure, the water in the water storage tank 9 can be used again for spraying plants by setting the water return pipe 91 and the water spray pipe 92, thus forming a water cycling system and avoiding the waste of water resources. When the water in the water storage tank 9 is insufficient, water is supplied to the water storage tank 9 through the water supply pipe 93, which ensures the continuity of the spray process, thereby improving the spray efficiency.

The basic concepts have been described above, and it is apparent to a person skilled in the art that the above detailed disclosure serves only as an example and does not constitute a limitation of the present disclosure. While not expressly stated herein, various modifications, improvements, and amendments may be made to the present disclosure by those skilled in the art. Those types of modifications, improvements, and amendments are suggested in the present disclosure, so those types of modifications, improvements, and amendments are still within the spirit and scope of the exemplary embodiments of the present disclosure.

Meanwhile, the present disclosure uses specific words to describe the embodiments of the present disclosure. such as “an embodiment”, “one embodiment”, and/or “some embodiment” means a feature, structure, or feature associated with at least one embodiment of the present disclosure. Accordingly, it should be emphasized and noted that “an embodiment” or “one embodiment” or “an alternative embodiment” in different places in the present disclosure do not necessarily refer to the same embodiment. In addition, certain features, structures, or characteristics of one or more embodiments of the present disclosure may be suitably combined.

In addition, the order in which the elements and sequences are processed in the present disclosure, the use of numerical letters, or the use of other names is not intended to qualify the order of the processes and methods of the present disclosure. While a number of embodiments of the disclosure that are currently considered useful are discussed in the foregoing disclosure by way of various examples, it should be appreciated that such details serve illustrative purposes only. For example, although the implementation of various components described above may be embodied in a hardware device, it may also be implemented as a software only solution, e.g., an installation on an existing server or mobile device.

Similarly, it should be noted that in order to simplify the expressions disclosed in the present disclosure and thereby facilitate the understanding of one or more embodiments of the present disclosure, in the preceding descriptions of the embodiments of the present disclosure, various features are sometimes grouped together into a single embodiment, accompanying drawing, or description thereof. In fact, the features of an embodiment are fewer than all the features of a single embodiment disclosed above.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required features of individual embodiments. In some embodiments, the numerical parameters should take into account the specified number of valid digits and employ general place-keeping. Although the numerical ranges and parameters used to define the breadth of their scope in some embodiments of the present disclosure are approximate values, in specific embodiments, the setting of such numerical values is made as precise as possible within the feasible range.

Finally, it should be understood that the embodiments in the present disclosure are used only to illustrate the principles of the embodiments of the present disclosure. Other deformations may also fall within the scope of the present disclosure. Therefore, by way of example and not limitation, alternative configurations of the embodiments of the present disclosure may be considered consistent with the teachings of the present disclosure. Correspondingly, the embodiments of the present disclosure are not limited to the embodiments expressly presented and described herein.

What is claimed is:

1. A spray device with an adjustable spray range, comprising:
a supporting wall frame, an upper top plate, a movable horizontal plate, a lifting and telescoping device, and an adjustable nozzle; wherein
the upper top plate is arranged at a first end of the supporting wall frame away from a ground, the movable horizontal plate is slidably connected to a side of the upper top plate away from the ground, the movable horizontal plate is slidably arranged along a length direction of the upper top plate, and the lifting and telescoping device is fixed at an end of the movable horizontal plate away from the upper top plate; and
an end of the lifting and telescoping device away from the movable horizontal plate is connected to a support plate, the lifting and telescoping device is telescopic along a height direction of the support plate, and the adjustable nozzle is rotatably arranged on the support plate.

2. The spray device according to claim 1, wherein the adjustable nozzle includes a nozzle housing, a rotation adjustment column, and a partition plate, wherein one end of the nozzle housing is provided with a water inlet and the other end of the nozzle housing is provided with a water outlet, and the rotation adjustment column is rotatably connected to the water outlet of the nozzle housing, the rotation adjustment column is rotatable with respect to the water outlet of the nozzle housing, the partition plate is arranged in an inner cavity of the rotation adjustment column, the partition plate divides the inner cavity of the rotation adjustment column into an inner ring water storage cavity and an outer ring water storage cavity, and the inner ring water storage cavity is located on an inner side of the outer ring water storage cavity.

3. The spray device according to claim 2, wherein a surface of an end of the rotation adjustment column close to the water outlet is provided with a plurality of inner ring spray holes and a plurality of outer ring spray holes, the inner ring spray holes are connected with the inner ring water storage cavity, and the outer ring spray holes are connected with the outer ring water storage cavity.

4. The spray device according to claim 3, wherein the adjustable nozzle further includes an adjusting fixing plate, wherein the adjusting fixing plate is arranged in the nozzle housing, the adjusting fixing plate is provided with a first outer ring through-hole and a first inner ring through-hole, the first outer ring through-hole is connected with the outer ring water storage cavity, and the first inner ring through-hole is connected with the inner ring water storage cavity.

5. The spray device according to claim 4, wherein a side of the outer ring water storage cavity close to the adjusting fixing plate is provided with a second outer ring through-hole, a side of the inner ring water storage cavity close to the adjusting fixing plate is provided with a second inner ring through-hole, the first outer ring through-hole is connected with the outer ring water storage cavity through the second outer ring through-hole, the first inner ring through-hole is connected with the inner ring water storage cavity through the second inner ring through-hole, and a center of the first outer ring through-hole, a center of the first inner ring through-hole, and a center of the adjusting fixing plate are not colinear.

6. The spray device according to claim 1, further comprising a plurality of fixing nozzles, wherein the plurality of fixing nozzles are arranged on a lower surface of the upper top plate.

7. The spray device according to claim 1, further comprising a traversing driving device, wherein the traversing driving device is connected to the movable horizontal plate.

8. The spray device according to claim 1, wherein a surface of the upper top plate close to the movable horizontal plate is provided with a slide rail, a surface of the movable horizontal plate close to the upper top plate is provided with a slider, and the slider is slidably connected with the slide rail.

9. The spray device according to claim 8, wherein the traversing driving device is a driving hydraulic cylinder, the driving hydraulic cylinder is fixed to the upper top plate, and a telescopic end of the driving hydraulic cylinder is fixedly connected to the slider.

10. The spray device according to claim 1, wherein the support plate is provided with a motor bracket, the motor bracket is fixed with an angle adjusting motor, and the adjustable nozzle includes two connecting rods, the two connecting rods are respectively fixedly connected to two ends of the adjustable nozzle, the two connecting rods are rotatably connected to the motor bracket, and an output shaft of the angle adjusting motor is drivingly connected to a connecting rod close to the angle adjusting motor.

11. The spray device according to claim 1, wherein a water collection tank is provided at a lower end of the supporting wall frame.

12. The spray device according to claim 11, further comprising a water storage tank, wherein the water storage tank includes a water return pipe, a water spray pipe, and a water supply pipe; wherein
the water storage tank is connected to the water collection tank via the water return pipe;
the water storage tank is connected to the plurality of the fixing nozzles via the water spray pipe; and
the water storage tank is connected to a water source through the water supply pipe.

13. The spray device according to claim 12, wherein the water spray pipe is connected to a water inlet of the adjustable nozzle through a connecting hose.

14. The spray device according to claim 12, further comprising a liquid level sensor, wherein the level sensor is arranged in the water storage tank.

15. The spray device according to claim 12, wherein the water spray pipe is provided with a water pump.

16. The spray device according to claim 1, wherein the lifting and telescoping device is a hydraulic cylinder.
